(19) United States
(12) Patent Application Publication
(10) Pub. No.: US 2026/0287604 A1
(43) Pub. Date: Sep. 24, 2026

(54) AUTOMATIC ANALYSIS APPARATUS AND REACTION VESSEL

(71) Applicant: CANON MEDICAL SYSTEMS CORPORATION, Otawara-shi (JP)

(72) Inventor: Keigo FUJITA, Nasushiobara (JP)

(73) Assignee: CANON MEDICAL SYSTEMS CORPORATION, Otawara-shi (JP)

(21) Appl. No.: 19/532,179

(22) Filed: Feb. 6, 2026

(30) Foreign Application Priority Data
Mar. 18, 2025 (JP) 2025-043772

(51) Int. Cl. G01N 35/10; G01N 21/27; G01N 35/00

(52) U.S. Cl. CPC G01N 35/10; G01N 21/27; G01N 2035/00465; G01N 2035/1037

(57) ABSTRACT

An automatic analysis apparatus according to embodiments analyzes a liquid sample by measuring optical characteristics and includes a reaction vessel, an introduction unit, and a photometric system. The reaction vessel configured to contain a mixed solution of the liquid sample and a reagent, and have a reaction area where the mixed solution is caused to react, and a photometric area provided below the reaction area in a vertical direction, the photometric area being a target for a measurement of the optical characteristics. The introduction unit configured to introduce the mixed solution into the photometric area by applying a voltage to change wettability of the mixed solution to an inside surface of the photometric area. The photometric system configured to measure the optical characteristics of the mixed solution introduced into the photometric area.

### CROSS-REFERENCE TO RELATED APPLICATIONS

This application is based upon and claims the benefit of priority from Japanese Patent Application No. 2025-043772, filed Mar. 18, 2025, the entire contents of which are incorporated herein by reference.

### FIELD

Embodiments of the present disclosure relate to an automatic analysis apparatus and a reaction vessel.

### BACKGROUND

Conventionally, automatic analysis apparatuses have been used in medical institutions in order to automatically measure concentration and activity of various components contained in a test sample collected from a subject. For example, the automatic analysis apparatus mixes a liquid sample which contains blood, urine, stool, and/or somatic cells collected from a subject with a reagent according to a test item, and measures concentration and activity of a desired component by detecting a change in optical characteristics of the mixed solution.

In certain cases, collecting a test sample from a subject, such as blood sampling, may impose a significant burden on the subject. Therefore, there is a demand for automatic analysis apparatuses capable of performing measurements using as little sample as possible. Further, it is generally known that if the amount of a test sample to be used for measurement can be reduced, the amount of a reagent to be mixed with a test sample can also be reduced.

Accordingly, it can be said that minimization of a test sample and a reagent to be used for measurements results in reduction of a burden imposed on a subject and decrease in cost. It is also known that minimization of a test sample and a reagent results in miniaturization of automatic analysis apparatuses.

Therefore, various techniques for achieving minimization of a test sample and a reagent to be used for measurement have been proposed. As an example of such a technique, a technique for reducing the volume of a photometric area has been known. The photometric area is a target where optical characteristics are measured, which is included in a reaction vessel where a test sample and a reagent are mixed.

However, in a case where volume of the photometric area of the reaction vessel is reduced, there is a possibility that a mixed solution of a test sample and a reagent is not easily introduced into the photometric area because of the surface tension of the mixed solution. Further, because of a similar reason, there is a possibility that a cleaning solution is not easily introduced into the photometric area during cleaning of the reaction vessel.

### BRIEF DESCRIPTION OF THE DRAWINGS

FIG. 1 is a block diagram illustrating an example of a configuration of an automatic analysis apparatus according to an embodiment;

FIG. 2 is a diagram illustrating an example of a configuration of an analysis mechanism according to the embodiment;

FIG. 3 is a perspective view illustrating an example of a configuration of a reaction vessel according to the embodiment;

FIG. 4 is a front view illustrating an example of a configuration of the reaction vessel according to the embodiment;

FIG. 5 is a flowchart illustrating an example of processing that is performed by the automatic analysis apparatus according to the embodiment;

FIG. 6 is a diagram illustrating an example of a test sample dispensed to the reaction vessel, according to the embodiment;

FIG. 7 is a diagram illustrating an example of a test sample to which a voltage is applied, according to the embodiment;

FIG. 8 is a diagram illustrating an example of a test sample when application of the voltage is stopped, according to the embodiment;

FIG. 9 is a diagram illustrating an example of a reaction solution in the reaction vessel after a first reagent is dispensed, according to the embodiment;

FIG. 10 is a diagram illustrating a processing example of stirring the reaction solution in the reaction vessel according to the embodiment;

FIG. 11 is a diagram illustrating an example of the reaction solution to which a voltage is applied, according to the embodiment;

FIG. 12 is a diagram illustrating an example of the reaction solution when application of the voltage is stopped, according to the embodiment;

FIG. 13 is a diagram illustrating a processing example of aspiration of the reaction solution according to the embodiment;

FIG. 14 is a diagram illustrating an example of a cleaning solution that has been dispensed to the reaction vessel according to the embodiment;

FIG. 15 is a diagram illustrating an example of a cleaning solution to which a voltage is applied, according to the embodiment;

FIG. 16 is a diagram illustrating a processing example of stirring the cleaning solution in the reaction vessel according to the embodiment;

FIG. 17 is a diagram illustrating a processing example of aspiration of a cleaning solution according to the embodiment;

FIG. 18 is a diagram illustrating an example of a configuration of a reaction vessel according to Variation Example 1;

FIG. 19 is a front view illustrating an example of a configuration of a reaction vessel according to Variation Example 2;

FIG. 20 is a front view illustrating an example of a configuration of the reaction vessel according to Variation Example 2;

FIG. 21 is a front view illustrating an example of a configuration of a reaction vessel according to Variation Example 3; and

FIG. 22 is a front view illustrating an example of a configuration of a reaction vessel according to Variation Example 4.

### DETAILED DESCRIPTION

An automatic analysis apparatus according to embodiments analyzes a liquid sample by measuring optical characteristics and includes a reaction vessel, an introduction unit, and a photometric system. The reaction vessel configured to contain a mixed solution of the liquid sample and a reagent, and have a reaction area where the mixed solution is caused to react, and a photometric area provided below the reaction area in a vertical direction, the photometric area being a target for a measurement of the optical characteristics. The introduction unit configured to introduce the mixed solution into the photometric area by applying a voltage to change wettability of the mixed solution to an inside surface of the photometric area. The photometric system configured to measure the optical characteristics of the mixed solution introduced into the photometric area.

Various embodiments will be described hereinafter with reference to the accompanying drawings.

An automatic analysis apparatus according to the present application is not limited to the embodiments described below. Furthermore, the embodiment can be combined with other embodiments or conventional techniques within a range that does not cause inconsistency in the processing contents.

For convenience of explanation, coordinate axes are shown in each figure. A longitudinal direction of the automatic analysis apparatus is defined as an X-axis direction (width direction), a lateral direction is defined as a Y-axis direction (front-rear direction), and a direction orthogonal to both the X-axis and Y-axis is defined as a Z-axis direction (vertical direction).

A direction indicated by an arrow of the X-axis corresponds to the right side, and the opposite direction corresponds to the left side. A direction indicated by an arrow of the Y-axis corresponds to the rear side, and the opposite direction corresponds to the front side. A direction indicated by an arrow of the Z-axis corresponds to the upper side, and the opposite direction corresponds to the lower side. In each figure, for convenience of explanation, the components may be appropriately enlarged, reduced, or omitted. Furthermore, in order to clearly describe the automatic analysis apparatus according to the present embodiment, components not directly related to the present embodiment are omitted.

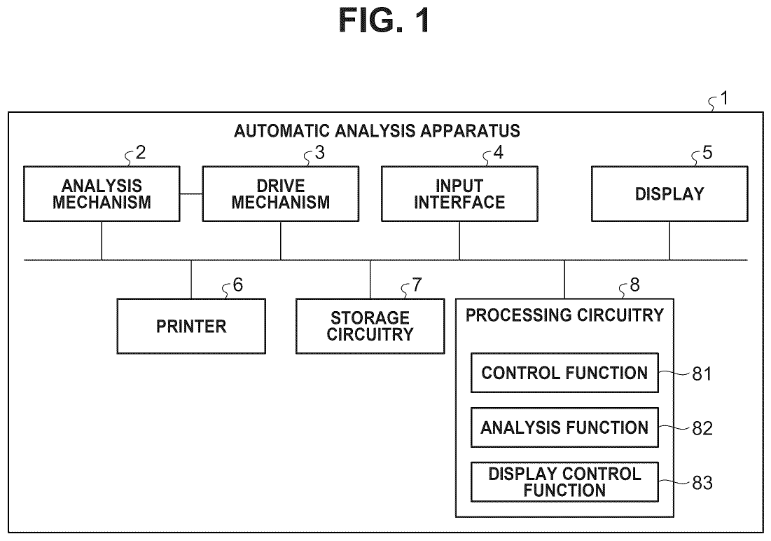

First, an example of a configuration of the automatic analysis apparatus according to the embodiment is described with reference to FIG. 1. FIG. 1 is a block diagram illustrating an example of a configuration of an automatic analysis apparatus 1 according to the embodiment. As illustrated in FIG. 1, for example, the automatic analysis apparatus 1 according to a first embodiment includes an analysis mechanism 2, a drive mechanism 3, an input interface 4, a display 5, a printer 6, a storage circuitry 7, and a processing circuitry 8. The analysis mechanism 2, the drive mechanism 3, the input interface 4, the display 5, the printer 6, the storage circuitry 7, and the processing circuitry 8 are connected to each other to be capable of communicating with each other.

The analysis mechanism 2 includes various units for performing automatic analysis, and performs a series of operations related to measurement of a predetermined component contained in a test sample (specimen) in accordance with a preset cycle time set by the drive mechanism 3. The test sample is an example of a liquid sample. The cycle time is one of parameters that determine measurement throughput (the number of tests measurable in a certain period of time) of the automatic analysis apparatus 1.

The analysis mechanism 2 mixes a test sample collected from a subject with a reagent for a desired test item. Then, the analysis mechanism 2 measures optical characteristics of a mixed solution of the test sample and the reagent, and generates test data expressed by, for example, absorbance. Further, the analysis mechanism 2 mixes a standard sample for a predetermined test item with the reagent for the predetermined test item.

The standard sample is a solution having a known concentration or activity of a component to be analyzed in a test item. The analysis mechanism 2 measures optical characteristics of a mixed solution of the standard sample and the reagent, and generates standard data expressed as, for example, absorbance. The generated test data and the standard data are output to the processing circuitry 8. Hereinafter, the test sample and the standard sample may collectively be called “specimen” or “sample”. Further, an operation for measuring optical characteristics may be called “photometry”.

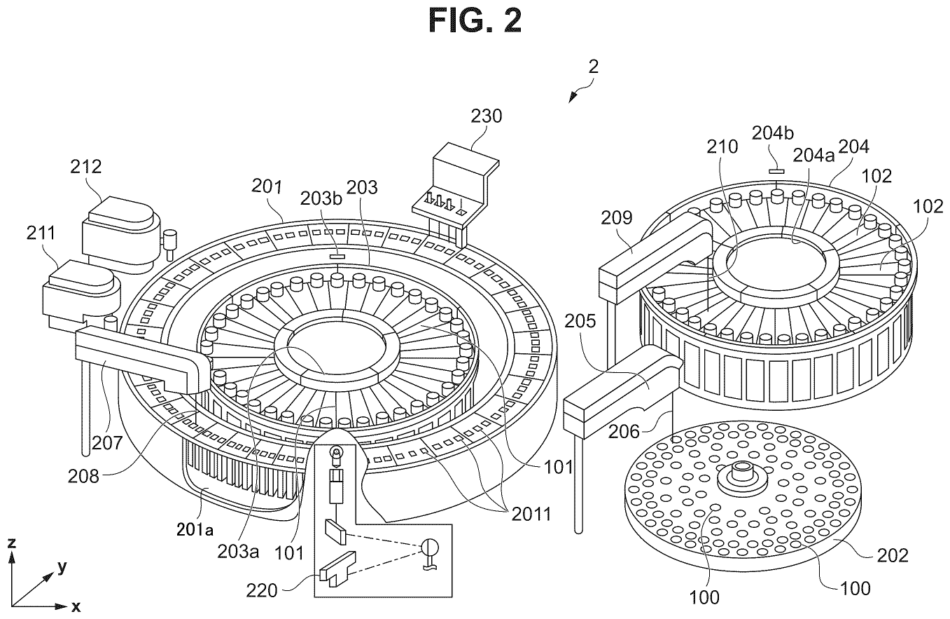

FIG. 2 is a diagram illustrating an example of a configuration of the analysis mechanism 2 according to the embodiment. As illustrated in FIG. 2, the analysis mechanism 2 includes a reaction disk 201, a sample disk 202, a first reagent storage 203, a reagent vessel rack 203a, a reader 203b, a second reagent storage 204, a reagent vessel rack 204a, and a reader 204b.

The analysis mechanism 2 further includes a sample dispensing arm 205, a sample dispensing probe 206, a first reagent dispensing arm 207, a first reagent dispensing probe 208, a second reagent dispensing arm 209, a second reagent dispensing probe 210, a first stirring unit 211, and a second stirring unit 212. Further, the analysis mechanism 2 includes a photometric unit 220 and a cleaning unit 230.

The reaction disk 201 holds a plurality of reaction vessels 2011 arranged in a circular configuration. Further, the reaction disk 201 includes a thermostatic bath 201a for maintaining a solution in the reaction vessels 2011 at a constant temperature. In the present embodiment, the thermostatic bath 201a is a water tank in which temperature-controlled water is stored. The temperature-controlled water is, for example, degassed pure water. The reaction vessels 2011 are immersed in the temperature-controlled water.

The reaction disk 201 is driven by the drive mechanism 3 to alternately repeat a rotational movement and a stop at a predetermined time interval set as a cycle time. As described above, the reaction disk 201 rotates and stops, so that each of the reaction vessels 2011 held in the reaction disk 201 is moved by a predetermined angle in a predetermined direction.

Each of the reaction vessels 2011 is a vessel which contains a mixed solution of a test sample and a reagent therein. Each of the reaction vessels 2011 is also called a “cell” or a “cuvette”. For example, the reaction vessels 2011 are formed of glass or quartz. The reaction vessels 2011 which contain a mixed solution of a test sample and a reagent therein are immersed in constant temperature water, so that reaction between the test sample and the reagent progresses. Therefore, a mixed solution of a test sample and a reagent is also called a “reaction solution”.

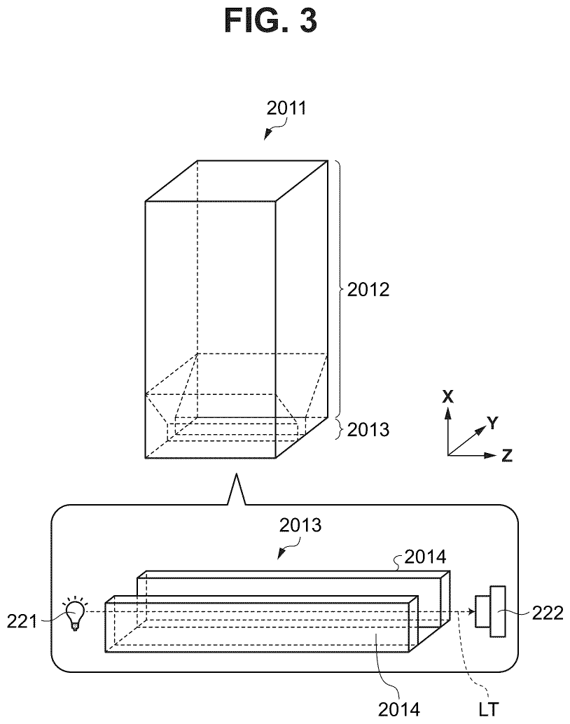

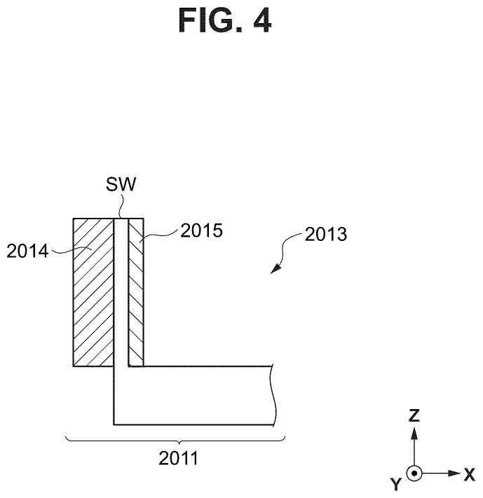

Further, each of the reaction vessels 2011 has a photometric area 2013 that contains the reaction solution during photometry (see FIGS. 3 and 4).

A surface of a side wall of the photometric area 2013, which is in contact with a reaction solution (hereinafter, called an inside surface), is formed so that wettability to the inside surface of the side wall of the photometric area 2013 (hereinafter, simply called “wettability”) of the solution being in contact with the inside surface of the side wall of the photometric area 2013 is to be changed. The reaction vessel 2011 having the structure for changing the wettability of the solution being in contact with the inside surface of the side wall of the photometric area 2013 is described below.

The sample disk 202 holds a plurality of sample vessels 100 each containing a sample and is rotationally moved by the drive mechanism 3.

The first reagent storage 203 keeps reagent vessels 101 cool, and each of the reagent vessels 101 contains a first reagent that reacts with a predetermined component contained in the standard sample and the test sample. The first reagent storage 203 holds the plurality of reagent vessels 101 circumferentially arranged in the reagent vessel rack 203a. The reagent vessel rack 203a is rotationally moved about a center of the first reagent storage 203 by the drive mechanism 3.

In a state where rear portions of the reagent vessels 101 face toward the outer side of the first reagent storage 203, the reagent vessels 101 are rotationally moved and stopped once per cycle time along with the rotational movement and the stop of the reagent vessel rack 203a. In this way, according to the order of test items specified by the processing circuitry 8, the reagent vessels 101 each containing a necessary first reagent are moved to a predetermined position, such as a position where the reagent is aspirated.

The reagent vessels 101 held in the reagent vessel rack 203a contain, for example, a first reagent to be used for a basic test item. In this embodiment, the basic test item refers to, for example, a test item that is requested for almost all samples and is frequently requested. For example, the basic test item include test items that are commonly requested for all persons who take medical examinations.

The basic test items include, for example, Total Protein, Aspartate Aminotransferase (AST) (Glutamate Oxaloacetate Transaminase (GOT)), Alanine Aminotransferase (ALT) (Glutamate Pyruvate Transaminase (GPT)), Gamma-Glutamyltransferase (γ-GT), Triglyceride, High-Density Lipoprotein-Cholesterol (HDL-Cholesterol), Low-Density Lipoprotein-Cholesterol (LDL-Cholesterol), Urea Nitrogen, Creatinine, and Uric Acid.

The basic test items are set previously. For example, a basic test item list describing which test items are specified as basic test items is previously stored in the storage circuitry 7. In this embodiment, for example, character strings expressing names of test items specified as basic test items are included in the basic test item list. In addition, the test items included in the basic test item list may be set by an operator via the input interface 4.

A recording medium for recording identification information on a reagent contained in the reagent vessel 101 is provided to each of the reagent vessels 101. In this embodiment, the identification information on the reagent includes, for example, a name of a reagent, a name of a test item using the reagent, a lot number, a reagent vessel type, and an expiration date of the reagent.

For example, the recording medium is an optically-readable optical mark or a radio frequency identification (RFID) tag readable by wireless communication. The optical mark is a mark in which identification information on a reagent contained in the reagent vessels 101 is encoded, such as a bar code, a one-dimensional code, and a two-dimensional code.

The reader 203b is disposed in a vicinity of the outer side of the first reagent storage 203, so that the reader 203b can read the optical mark attached to a rear portion of each of the reagent vessels 101 held in the reagent vessel rack 203a through a detection window provided in the outer wall of the first reagent storage 203.

The reader 203b reads the optical mark attached to the reagent vessel 101 at a timing such as when the reagent vessel 101 is loaded on the reagent vessel rack 203a, in response to a reading start instruction issued by the processing circuitry 8 as a trigger. The reader 203b supplies identification information on a reagent described in the read optical mark to the processing circuitry 8.

The second reagent storage 204 keeps reagent vessels 102 cool. Each of the reagent vessels 102 contains a second reagent that forms a pair with a first reagent in a two-reagent system. The second reagent storage 204 holds a plurality of reagent vessels 102 circumferentially arranged in the reagent vessel rack 204a. The reagent vessel rack 204a is rotationally moved about a center of the second reagent storage 204 by the drive mechanism 3.

Similar to the reagent vessels 101, in a state where rear face portions of the reagent vessels 102 face toward the outer side of the second reagent storage 204, the reagent vessels 102 are rotationally moved and stopped once per cycle time along with the rotational movement and the stop of the reagent vessel rack 204a. In this way, according to the order of test items specified by the processing circuitry 8, reagent vessels 102 each containing a necessary second reagent are moved to a predetermined position, such as a position where the reagent is aspirated.

The reagent vessels 102 held in the reagent vessel rack 204a include, for example, a reagent vessel 102 that contains a second reagent to be used for a basic test item therein. In some test items, the second reagent may not be provided.

A recording medium for recording identification information on a reagent contained in the reagent vessel 102 is provided to each of the reagent vessels 102. For example, the recording medium is an optically-readable optical mark or a RFID tag readable by wireless communication.

The reader 204b is disposed in a vicinity of the outer side of the second reagent storage 204, so that the reader 204b can read the optical mark attached to a rear face portion of each of the reagent vessels 102 held in the reagent vessel rack 204a through a detection window provided in the outer wall of the second reagent storage 204.

The reader 204b reads the optical mark attached to the reagent vessel 102 at a timing such as when the reagent vessel 102 is loaded on the reagent vessel rack 204a, in response to a reading start instruction issued by the processing circuitry 8 as a trigger. The reader 204b supplies identification information on a reagent described in the read optical mark to the processing circuitry 8.

The sample dispensing arm 205 is disposed between the reaction disk 201 and the sample disk 202, and can freely move up and down in the vertical direction and can freely move rotationally in the horizontal direction. The sample dispensing arm 205 holds the sample dispensing probe 206 at one end. The sample dispensing arm 205 is moved up and down and rotationally moved by the drive mechanism 3.

The sample dispensing probe 206 is rotationally moved along an arc-shaped rotational path in association with the rotational movement of the sample dispensing arm 205. On the rotational path, a sample aspiration position where the sample is aspirated from each of the sample vessels 100 by the sample dispensing probe 206 is provided. Further, at another point on the rotational path which is different from the sample aspiration position and on a rotational path of the reaction vessel 2011, a sample dispense position where a sample aspirated by the sample dispensing probe 206 is dispensed to the reaction vessel 2011 is provided.

The sample dispensing probe 206 is driven by the drive mechanism 3 to move in the up-down direction at the sample aspiration position and the sample dispense position. Further, under control of the processing circuitry 8, the sample dispensing probe 206 aspirates a sample from a sample vessel 100 positioned at the sample aspiration position. Furthermore, under control of the processing circuitry 8, the sample dispensing probe 206 dispenses the aspirated sample to the reaction vessel 2011 positioned at the sample dispense position.

The sample dispensing probe 206 can also dispense a cleaning solution to the reaction vessel 2011 positioned at the sample dispense position. In this embodiment, the cleaning solution is water for cleaning the inside surface of the sample dispensing probe 206.

The first reagent dispensing arm 207 is disposed in the vicinity of the outer circumference area of the reaction disk 201, and can freely move up and down in the vertical direction and freely rotate in the horizontal direction. The first reagent dispensing arm 207 holds the first reagent dispensing probe 208 at one end. The first reagent dispensing arm 207 is moved up and down and rotationally moved by the drive mechanism 3. The first reagent dispensing probe 208 is rotationally moved along an arc-shaped rotational path in association with the rotational movement of the first reagent dispensing arm 207.

On the rotational path, a first reagent aspiration position and a first reagent dispense position are set. At the first reagent aspiration position, the first reagent dispensing probe 208 aspirates a first reagent corresponding to a test item from the reagent vessel 101 which is disposed in the first reagent storage 203, and at the first reagent dispense position, the first reagent dispensing probe 208 dispenses the aspirated first reagent to the reaction vessel 2011.

The rotational path of the first reagent dispensing probe 208 crosses the rotational path of the reagent vessels 101 held in the reagent vessel rack 203a within the first reagent storage 203 and the rotational path of the reaction vessel 2011 held in the reaction disk 201. The points where the rotational path crosses the respective rotational paths are referred to as the first reagent aspiration position and the first reagent dispense position.

The first reagent dispensing probe 208 is driven by the drive mechanism 3 and is moved in the up-down direction at the first reagent aspiration position and the first reagent dispense position on the rotational path. Further, under control of the processing circuitry 8, the first reagent dispensing probe 208 aspirates a first reagent from a reagent vessel 101 positioned at the first reagent aspiration position. Furthermore, under control of the processing circuitry 8, the first reagent dispensing probe 208 dispenses the aspirated first reagent to a reaction vessel 2011 positioned at the first reagent dispense position.

The first reagent dispensing probe 208 can also dispense a cleaning solution to the reaction vessel 2011 positioned at the first reagent dispense position. In this embodiment, the cleaning solution is water for cleaning the inside surface of the first reagent dispensing probe 208.

The second reagent dispensing arm 209 is arranged between the reaction disk 201 and the second reagent storage 204, and can freely move up and down in the vertical direction and freely rotate in the horizontal direction. The second reagent dispensing arm 209 holds the second reagent dispensing probe 210 at one end. The second reagent dispensing arm 209 is moved up and down and rotationally moved by the drive mechanism 3. The second reagent dispensing probe 210 is rotationally moved along an arc-shaped rotational path in association with the rotational movement of the second reagent dispensing arm 209.

On the rotational path, a second reagent aspiration position and a second reagent dispense position are provided. At the second reagent aspiration position, the second reagent dispensing probe 210 aspirates a second reagent corresponding to a test item from the reagent vessel 102 which is held in the reagent vessel rack 204a disposed in the second reagent storage 204, and at the second reagent dispense position, the second reagent dispensing probe 210 dispenses the aspirated second reagent to the reaction vessel 2011.

The rotational path of the second reagent dispensing probe 210 crosses the rotational path of the reagent vessels 102 held in the reagent vessel rack 204a disposed in the second reagent storage 204 and the rotational path of the reaction vessels 2011 held in the reaction disk 201. The points where the rotational path crosses the respective rotational paths are referred to as the second reagent aspiration position and the second reagent dispense position.

The second reagent dispensing probe 210 is driven by the drive mechanism 3 and is moved in the up-down direction at the second reagent aspiration position and the second reagent dispense position on the rotational path. Further, under control of the processing circuitry 8, the second reagent dispensing probe 210 aspirates a second reagent from the reagent vessel 102 positioned at the second reagent aspiration position. Furthermore, under control of the processing circuitry 8, the second reagent dispensing probe 210 dispenses the aspirated second reagent to the reaction vessel 2011 positioned at the second reagent dispense position.

The second reagent dispensing probe 210 can also dispense a cleaning solution to a reaction vessel 2011 positioned at the second reagent dispense position. In this embodiment, the cleaning solution is water for cleaning the inside surface of the second reagent dispensing probe 210.

The first stirring unit 211 and the second stirring unit 212 are disposed in the vicinity of the outer circumference area of the reaction disk 201. The first stirring unit 211 includes a first stirring arm and a first stirrer disposed on a leading end of the first stirring arm. The first stirring unit 211 stirs a mixed solution of a sample and a first reagent contained in the reaction vessel 2011 positioned at a first stirring position on the reaction disk 201 by the first stirrer.

The second stirring unit 212 includes a second stirring arm and a second stirrer disposed on a leading end of the second stirring arm. The second stirring unit 212 stirs a mixed solution of a sample, a first reagent, and a second reagent contained in the reaction vessel 2011 positioned at a second stirring position on the reaction disk 201 by the second stirrer.

The photometric unit 220 is an example of a photometric system. The photometric unit 220 is disposed in a vicinity of a photometric position. The photometric position is previously set on the reaction disk 201. The photometric unit 220 optically measures components of the mixed solution contained in the reaction vessel 2011.

As illustrated in FIG. 3, the photometric unit 220 includes a light source 221 and a light detection device 222. The light source 221 and the light detection device 222 are disposed to face each other across the reaction vessel 2011 positioned at the photometric position.

Under control of the processing circuitry 8, the photometric unit 220 emits light from the light source 221. The light detection device 222 detects light emitted from the light source 221 at, for example, a sampling interval synchronized with the cycle time. By the above-described operation, the light detection device 222 detects light passed through a mixed solution dispensed into the reaction vessel 2011.

Based on intensity of detected light, the light detection device 222 generates standard data or test data expressed by, for example, absorbance. The photometric unit 220 outputs the generated standard data and test data to the processing circuitry 8.

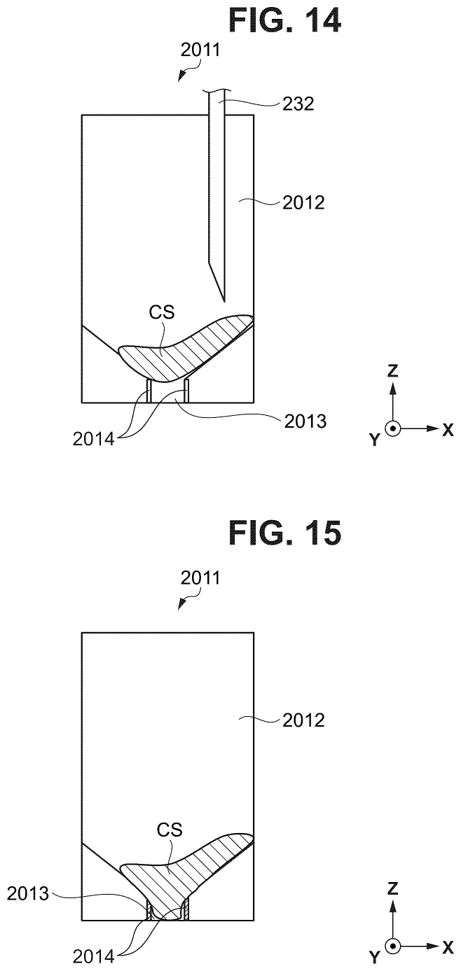

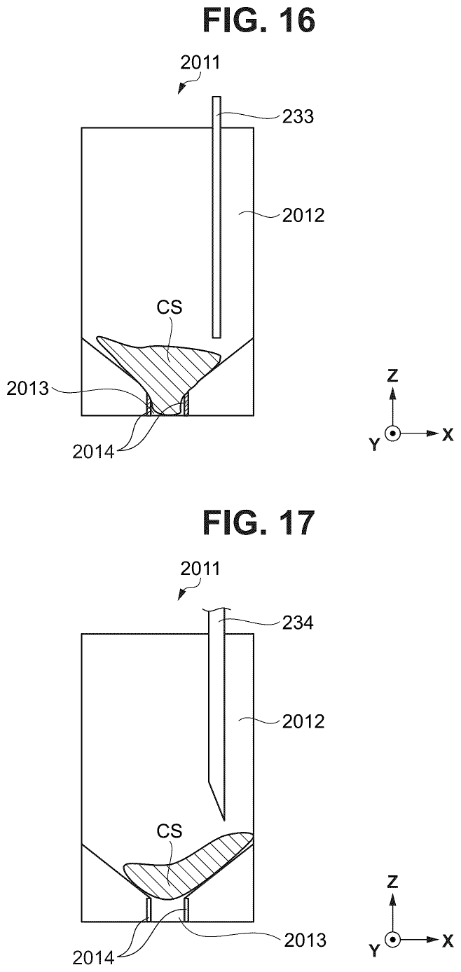

The cleaning unit 230 includes a first waste solution nozzle 231 (see FIG. 13), a cleaning nozzle 232 (see FIG. 14), a cleaning stirring arm 233 (see FIG. 16), and a second waste solution nozzle 234 (see FIG. 17). A cleaning stirrer is disposed on a leading end of the cleaning stirring arm 233.

The cleaning unit 230 aspirates a mixed solution in the reaction vessel 2011 positioned at a reaction vessel cleaning position as a waste solution by the first waste solution nozzle 231. Then, the cleaning unit 230 dispenses a cleaning solution to the reaction vessel 2011 positioned at the reaction vessel cleaning position by the cleaning nozzle 232.

Then, the cleaning unit 230 stirs the cleaning solution dispensed to the reaction vessel 2011 by the cleaning stirrer provided on the cleaning stirring arm 233, and cleans the reaction vessel 2011. Then, the cleaning unit 230 aspirates the cleaning solution in the reaction vessel 2011 as a waste solution by the second waste solution nozzle 234.

The cleaning unit 230 may further include a drying nozzle. In this case, the cleaning unit 230 dries the reaction vessel 2011 cleaned with the cleaning solution by supplying dry air to the reaction vessel 2011 through the drying nozzle.

Referring back to FIG. 1, and the description continues. The drive mechanism 3 is implemented by components, such as a gear, a stepping motor, a belt conveyer, and a lead screw. The drive mechanism 3 drives the analysis mechanism 2 based on the control performed by the processing circuitry 8.

The input interface 4 is connected to the processing circuitry 8. The input interface 4 converts an input operation accepted from the user to an electric signal, and outputs the electric signal to the processing circuitry 8. The input interface 4 is implemented by components, such as a track ball, a switch button, a mouse, a keyboard, a touch-pad allowing the user to input an operation by touching an operating surface, a touch screen in which a display screen and a touch-pad are integrated, a non-contact input circuitry using an optical sensor, and a sound input circuitry.

The input interface 4 is not limited to a device having physical operation parts, such as a mouse and a keyboard. A processing circuitry for electric signals which receives an electric signal corresponding to an input operation from an external input device disposed separately from the automatic analysis apparatus 1 and outputs the received electric signal to the processing circuitry 8 is also included in the example of the input interface 4. For example, the input interface 4 accepts a setting for analysis parameters of test items with respect to a sample.

The display 5 displays a graphical user interface (GUI) for allowing an operator to input various setting requests via the input interface 4, and also displays analysis data describing an analysis result acquired by the automatic analysis apparatus 1. For example, the display 5 is implemented by components, such as a liquid crystal display monitor, a cathode ray tube (CRT) display monitor, and a touch panel.

The printer 6 prints the analysis data supplied from the processing circuitry 8 on a printing sheet according to a preset format.

The storage circuitry 7 stores various programs for automatic analysis and information used by the programs. The storage circuitry 7 further stores test orders and processing results acquired by the processing circuitry 8. For example, the storage circuitry 7 stores analysis data describing an analysis result acquired by the automatic analysis apparatus 1. For example, the storage circuitry 7 is implemented by components, such as a random access memory (RAM), a semiconductor memory element, such as a flash memory, a hard disk, and an optical disk.

The processing circuitry 8 controls the entire processing that is performed by the automatic analysis apparatus 1. For example, the processing circuitry 8 collects test data generated by the automatic analysis apparatus 1, acquires analysis data based on the test data, and displays the analysis data, by reading and performing a control function 81, an analysis function 82, and a display control function 83 from the storage circuitry 7. The processing circuitry 8 is implemented by, for example, a processor.

In the present embodiment, respective processing functions described below are implemented by the processing circuitry 8, which is single circuitry. However, a processing circuitry may include a combination of a plurality of independent processors, and the functions may be implemented by the respective processors by performing programs.

The control function 81 controls the constituent elements included in the automatic analysis apparatus 1 according to an input operation accepted from the operator via the input interface 4.

For example, the control function 81 performs driving control of the respective constituent elements included in the analysis mechanism 2 by controlling the drive mechanism 3. Further, the control function 81 controls emission of light from the light source 221 and generation of standard data and test data via the light detection device 222 by controlling the photometric unit 220. The control function 81 further controls cleaning of the reaction vessel 2011 by controlling the cleaning unit 230.

Further, for example, the control function 81 generates standard data and test data by controlling the respective units included in the analysis mechanism 2 based on the test order. The standard data and the test data generated by the control function 81 are output to the analysis function 82, whereby the analysis function 82 generates analysis data.

Further, for example, the control function 81 performs control for introducing a solution (a test sample or a reaction solution) contained in a reaction area 2012 of the reaction vessel 2011 to the photometric area 2013 by changing the wettability of a solution contained in the reaction vessel 2011 at a timing when photometry is performed. Hereinafter, the control for changing wettability of a solution contained in the reaction vessel 2011 is described.

First, a configuration of the reaction vessel 2011 is described with reference to FIGS. 3 and 4. FIG. 3 is a perspective view illustrating an example of a configuration of the reaction vessel 2011 according to the embodiment. As illustrated in FIG. 3, the reaction vessel 2011 has the reaction area 2012 and the photometric area 2013.

In the reaction area 2012, a test sample is reacted with a reagent. The photometric area 2013 serves as a target area where optical characteristics are measured. The photometric area 2013 is provided on the lower side of the reaction area 2012 in the vertical direction.

Further, in the example in FIG. 3, the photometric area 2013 has a length in the vertical direction shorter than a length in the vertical direction of the reaction area 2012. Further, the photometric area 2013 has a length in the width direction approximately equal to a length in the width direction of a portion of the reaction area 2012 having a shortest length. Thus, a volume of the photometric area 2013 is smaller than a volume of the reaction area 2012.

Further, in the example in FIG. 3, an end portion of the reaction area 2012 on the lower side in the vertical direction is formed in a tapered shape that becomes narrower toward the photometric area 2013. Thus, a test sample or a reagent dropped into the reaction area 2012 tend to collect at the lower end portion of the reaction area 2012 under the influence of gravity.

The shape of the end portion of the reaction area 2012 on the lower side in the vertical direction is not limited to a tapered shape. For example, the shape of the end portion of the reaction area 2012 on the lower side in the vertical direction may be a hemispherical shape. A desirable shape of the end portion of the reaction area 2012 on the lower side in the vertical direction is a shape that allows the solution dropped into the reaction area 2012 to collect at the lower end portion. However, the end portion can be in any shape as long as the volume of the photometric area 2013 becomes smaller than the volume of the reaction area 2012.

Further, as illustrated in FIG. 3, in a case where the reaction vessel 2011 is positioned at the photometric position, the light source 221 and the light detection device 222 of the photometric unit 220 face each other across the photometric area 2013. Furthermore, as illustrated in FIG. 3, the photometric area 2013 has a length in a photometric direction (i.e., front-rear direction) longer than a length in the width direction.

In a case where the photometric area 2013 contains a reaction solution, light LT emitted from the light source 221 passes through the reaction solution and enters the light detection device 222. Thus, the photometric unit 220 can measure optical characteristics (e.g., absorbance) of the solution contained in the photometric area 2013.

Further, the photometric area 2013 has a conductive layer 2014 on surfaces (hereinafter, also called “outer surfaces”) opposite to inside surfaces of the side wall. The conductive layer 2014 is an electrode for generating electrowetting by application of a voltage.

The electrowetting is a phenomenon in which a contact angle of a droplet decreases (wettability is changed) when a potential difference is applied to an electrode and the droplet being in contact with the electrode. In the present embodiment, a hydrophobic coating has been applied to the inside surfaces of the side walls of the photometric area 2013 to form a hydrophobic layer, and the electrowetting is generated by applying voltage by the conductive layer 2014.

FIG. 4 is a front view illustrating an example of a configuration of the reaction vessel 2011 according to the embodiment. FIG. 4 illustrates an enlarged portion in the vicinity of the conductive layer 2014 disposed on the photometric area 2013 of the reaction vessel 2011 illustrated in FIG. 3.

As illustrated in FIG. 4, the conductive layer 2014 is disposed on the outer surface of the side wall of the photometric area 2013 (for the sake of clear illustration, the side wall is indicated by a symbol “SW” in FIG. 4). Further, a hydrophobic layer 2015 is formed on the inside surface of the side wall of the photometric area 2013.

Under control of the control function 81, the conductive layer 2014 changes the wettability of the solution being in contact with the inside surface of the side wall of the photometric area 2013 from hydrophobic to hydrophilic by applying a voltage. Further, under control of the control function 81, the conductive layer 2014 changes the wettability of the solution being in contact with the inside surface of the side wall of the photometric area 2013 from hydrophilic to hydrophobic by stopping application of the voltage.

For example, the conductive layer 2014 is a glassy carbon electrode (GCE) or an indium tin oxide (ITO) electrode. The conductive layer 2014 is not limited to the above, and electrodes of various types can be used as appropriate.

The hydrophobic layer 2015 is formed of a hydrophobic material, and is in contact with the solution contained in the photometric area 2013. The hydrophobic layer 2015 is formed of a polytetrafluoroethylene material, such as Teflon (registered trademark).

While, in the present embodiment, the conductive layer 2014 is disposed on the outer surface of the side wall SW of the photometric area 2013, in a case where the conductive layer 2014 is a transparent electrode, such as an ITO electrode, the conductive layer 2014 may be disposed on the inside surface of the side wall SW of the photometric area 2013 together with the hydrophobic layer 2015.

For example, after a test sample is dispensed to the reaction vessel 2011, the control function 81 applies a voltage to the test sample to change the wettability of the test sample being in contact with the inside surface of the side wall of the photometric area 2013 from hydrophobic to hydrophilic by controlling the conductive layer 2014 at a timing when photometry of the test sample is performed.

In this way, the test sample tends not to move to the photometric area 2013 from the reaction area 2012 because of the influence of the surface tension of the test sample, so that a possibility of photometric errors can be reduced.

Specifically, because a contact angle between the test sample and the inside surface of the side wall of the photometric area 2013 is reduced, the influence of the surface tension of the test sample is decreased. Due to the decrease in the influence of the surface tension of the test sample, the test sample contained in the reaction area 2012 of the reaction vessel 2011 falls due to gravity, whereby the test sample is contained in the photometric area 2013.

Further, after photometry of the test sample is ended, for example, the control function 81 stops applying the voltage to the test sample by controlling the conductive layer 2014 to change the wettability of the test sample being in contact with the inside surface of the side wall of the photometric area 2013 from hydrophilic to hydrophobic.

In a case where the wettability of the test sample remains hydrophilic, the test sample easily adheres to the inside surface of the side wall of the photometric area 2013. If the test sample adheres to the inside surface of the side wall of the photometric area 2013, adhesion of the test sample to the inside surface of the side wall of the photometric area 2013 cannot be removed even if stirring is performed when the first reagent is dispensed to the reaction area 2012. Therefore, there is a possibility that the test sample is not sufficiently mixed with the first reagent.

By changing the wettability of the test sample from hydrophilic to hydrophobic, the test sample does not easily adhere to the inside surface of the side wall of the photometric area 2013. Therefore, a possibility of insufficient mixing of the test sample and the first reagent can be reduced.

Further, for example, after the first reagent is dispensed to the reaction vessel 2011 and stirred, the control function 81 applies a voltage to the reaction solution by controlling the conductive layer 2014 at a timing when photometry of the reaction solution is performed, to change the wettability of the reaction solution being in contact with the inside surface of the side wall of the photometric area 2013 from hydrophobic to hydrophilic.

In this way, due to the influence of the surface tension of the reaction solution, the reaction solution cannot easily move to the photometric area 2013 from the reaction area 2012, and thus a possibility of photometric errors can be reduced.

Further, for example, when photometry of the reaction solution is ended after the first reagent is dispensed and stirred, the control function 81 stops applying a voltage to the reaction solution by controlling the conductive layer 2014 to change the wettability of the reaction solution being in contact with the inside surface of the side wall of the photometric area 2013 from hydrophilic to hydrophobic.

In this way, when the second reagent is dispensed, a possibility of insufficient mixing of the reaction solution and the second reagent can be reduced. Further, in a case of a test item without the second reagent, since the reaction solution does not tend to adhere to the inside surface of the side wall of the photometric area 2013, remaining of a part of the reaction solution adhered to the inside surface of the side wall of the photometric area 2013 is less likely to occur, which can reduce a possibility that reaction of the test sample and the first reagent does not proceed as expected.

Further, for example, the control function 81 applies a voltage to the reaction solution by controlling the conductive layer 2014 at a timing when final photometry of the reaction solution is performed to change the wettability of the reaction solution being in contact with the inside surface of the side wall of the photometric area 2013 from hydrophobic to hydrophilic. In this way, a possibility of photometric errors in the reaction solution can be reduced.

Further, for example, after the final photometry of the reaction solution is ended, for example, the control function 81 stops applying the voltage to the reaction solution by controlling the conductive layer 2014 to change the wettability of the reaction solution being in contact with the inside surface of the side wall of the photometric area 2013 from hydrophilic to hydrophobic. In this way, when the reaction solution is aspirated as a waste solution by the first waste solution nozzle 231, it is possible to reduce a possibility of remaining of the reaction solution adhered to the inside surface of the side wall of the photometric area 2013 of the reaction vessel 2011.

Further, for example, the control function 81 applies a voltage to the reaction solution by controlling the conductive layer 2014 when the cleaning solution is dispensed by the cleaning nozzle 232 to change the wettability of the cleaning solution being in contact with the inside surface of the side wall of the photometric area 2013 from hydrophobic to hydrophilic. In this way, due to the influence of the surface tension of the cleaning solution, the cleaning solution tends not to move to the photometric area 2013 from the reaction area 2012, and thus a possibility of insufficient cleaning of the photometric area 2013 can be reduced.

Further, for example, the control function 81 stops applying a voltage to the cleaning solution by controlling the conductive layer 2014 when the cleaning solution is aspirated as a waste solution by the second waste solution nozzle 234 to change the wettability of the cleaning solution being in contact with the inside surface of the side wall of the photometric area 2013 from hydrophilic to hydrophobic.

In this way, when the cleaning solution is aspirated as a waste solution by the second waste solution nozzle 234, it is possible to reduce the possibility that the cleaning solution remains adhered to the inside surface of the side wall of the photometric area 2013, which may affect the next measurement.

The analysis function 82 performs data analysis. For example, based on standard data, the analysis function 82 generates a calibration curve corresponding to each test item. The calibration curve is a graph representing a relationship between a concentration or activity of a component to be analyzed in the test item and optical characteristics, such as absorbance.

For example, the analysis function 82 plots absorbance corresponding to a different concentration of a plurality of concentrations, and generates a calibration curve based on a least-square method. Then, the analysis function 82 fits absorbance related to test data to the generated calibration curve to generate analysis data indicating a concentration or activity of the component corresponding to the absorbance. The analysis function 82 stores the generated analysis data in the storage circuitry 7.

The display control function 83 displays various information on a display apparatus. For example, the display control function 83 displays a processing result acquired by the control function 81 and the analysis function 82 on the display 5. For example, the display control function 83 displays the analysis data generated by the analysis function 82 on the display 5.

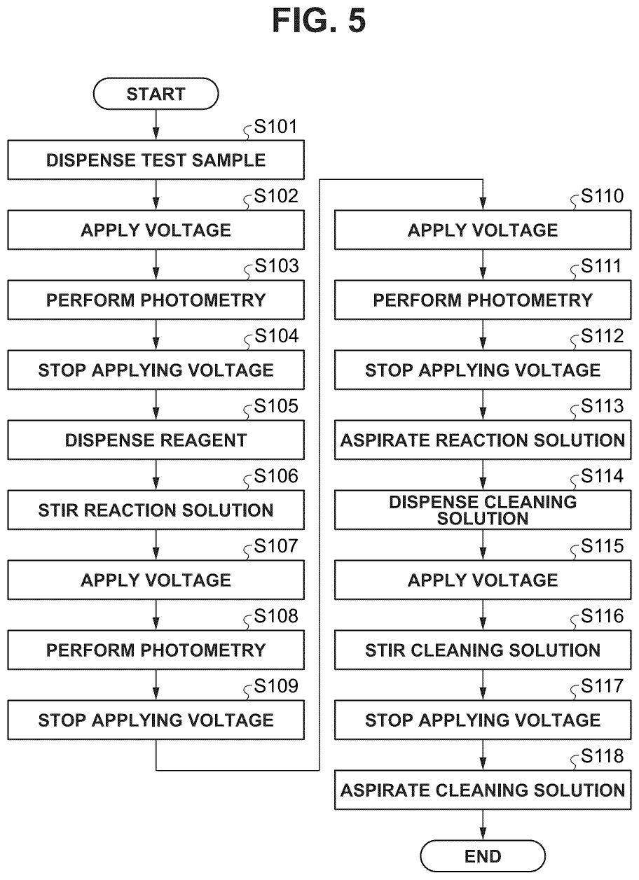

Next, processing that is performed by the automatic analysis apparatus 1 according to the embodiment is described. FIG. 5 is a flowchart illustrating an example of the processing that is performed by the automatic analysis apparatus 1 according to the embodiment. FIG. 5 illustrates an example of a procedure of the processing in a measurement for a test item without the second reagent.

First, in step S101, the control function 81 dispenses a test sample to the reaction vessel 2011. For example, by controlling the sample dispensing probe 206, the control function 81 aspirates a test sample from the sample vessel 100 positioned at the sample aspiration position and dispenses the test sample to the reaction vessel 2011 positioned at the sample dispense position.

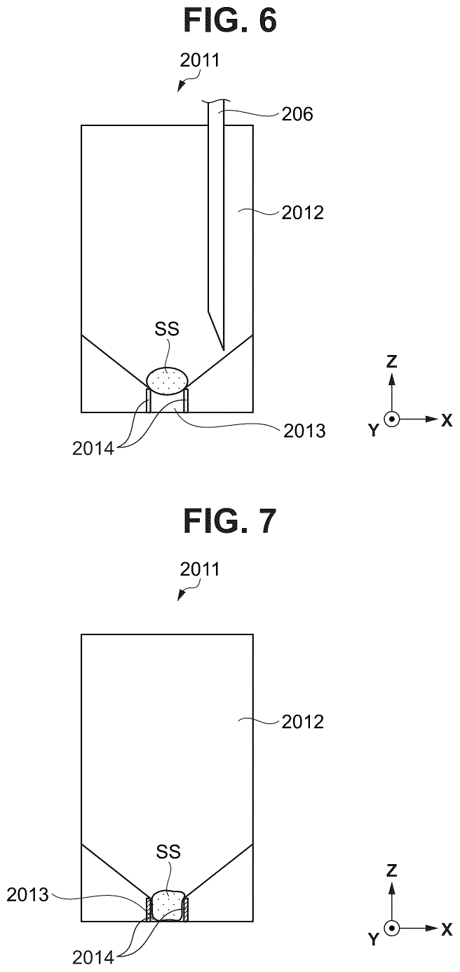

FIG. 6 is a diagram illustrating an example of a test sample SS dispensed to the reaction vessel 2011 according to the embodiment. In the example in FIG. 6, a voltage is not applied to the test sample SS dispensed to the reaction vessel 2011 by the sample dispensing probe 206, and thus, the wettability is hydrophobic. Therefore, even under the influence of gravity, the test sample SS does not fall due to the influence of the surface tension and remains at the bottom portion of the reaction area 2012.

Referring back to FIG. 5, and the description continues. After the processing in step S101, in step S102, the control function 81 applies a voltage to the test sample. For example, the control function 81 applies a voltage to the test sample by controlling the conductive layer 2014 disposed on the reaction vessel 2011.

FIG. 7 is a diagram illustrating an example of the test sample to which the voltage is applied according to the embodiment. In the example in FIG. 7, the voltage is applied to the test sample SS, so that the wettability is changed from hydrophobic to hydrophilic. Therefore, the test sample SS in FIG. 7 falls under the influence of gravity and is contained in the photometric area 2013. This can reduce a possibility of photometric errors.

Referring back to FIG. 5, and the description continues. After the processing in step S102, in step S103, the control function 81 performs photometry of the test sample. For example, by controlling the photometric unit 220, the control function 81 emits light from the light source 221 and measures absorbance of the test sample contained in the photometric area 2013 of the reaction vessel 2011 by the light detection device 222.

Next, in step S104, the control function 81 stops applying the voltage to the test sample. For example, the control function 81 stops applying the voltage to the test sample by controlling the conductive layer 2014 disposed on the reaction vessel 2011.

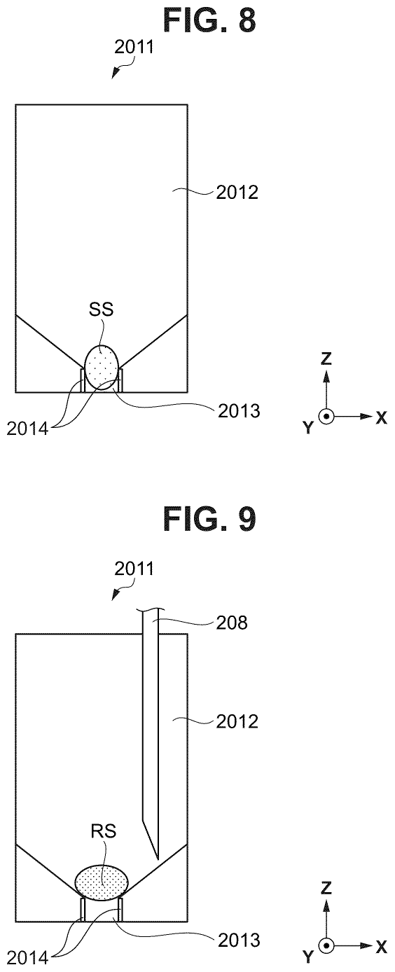

FIG. 8 is a diagram illustrating an example of the test sample when application of the voltage is stopped according to the embodiment. In the example in FIG. 8, the voltage is not applied to the test sample SS, so that the wettability is hydrophobic.

Therefore, in FIG. 8, a portion of the test sample SS being in contact with the side wall of the photometric area 2013 is reduced in comparison to a state in which the wettability is hydrophilic (see FIG. 7). Further, in FIG. 8, a portion of the test sample SS present in the reaction area 2012 is increased in comparison to a state in which the wettability is hydrophilic (see FIG. 7).

In this way, it is possible to reduce a possibility of insufficient mixing of the test sample SS and a first reagent caused by adhesion of a part of the test sample SS to the side wall of the photometric area 2013 when the first reagent is dispensed.

Referring back to FIG. 5, and the description continues. After the processing in step S104, in step S105, the control function 81 dispenses the first reagent to the reaction vessel 2011. For example, by controlling the first reagent dispensing probe 208, the control function 81 aspirates the first reagent from the reagent vessel 101 positioned at the first reagent aspiration position and dispenses the first reagent to the reaction vessel 2011 positioned at the first reagent dispense position.

FIG. 9 is a diagram illustrating an example of the reaction solution in the reaction vessel 2011 after the first reagent has been dispensed, according to the embodiment. FIG. 9 illustrates a state where a droplet of the first reagent dispensed to the reaction vessel 2011 by the first reagent dispensing probe 208 is in contact with a portion of a droplet of the test sample present in the reaction area 2012, so that one large droplet (reaction solution RS) is formed.

In the example illustrated in FIG. 9, the wettability of the reaction solution RS is hydrophobic. Therefore, the reaction solution RS stays at the bottom portion of the reaction area 2012 due to the influence of the surface tension.

Referring back to FIG. 5, and the description continues. After the processing in step S105, in step S106, the control function 81 stirs the reaction solution. For example, by controlling the first stirring unit 211, the control function 81 stirs the reaction solution contained in the reaction vessel 2011 positioned at the first stirring position on the reaction disk 201 using the first stirrer.

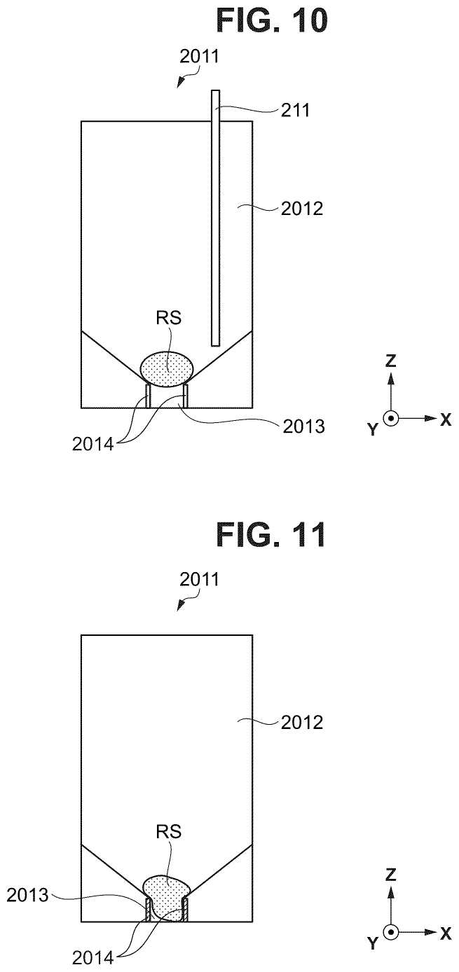

FIG. 10 is a diagram illustrating an example of processing for stirring the reaction solution in the reaction vessel 2011 according to the embodiment. In the example in FIG. 10, the wettability of the reaction solution RS is hydrophobic. Therefore, adhesion of part of the reaction solution RS to the side wall of the photometric area 2013 is less likely to occur. Accordingly, there is a high possibility that the test sample and the first reagent are sufficiently mixed by the first stirring unit 211 in the reaction area 2012.

Referring back to FIG. 5, and the description continues. After the processing in step S106, in step S107, similar to the processing in step S102, the control function 81 applies a voltage to the reaction solution.

FIG. 11 is a diagram illustrating an example of the reaction solution to which the voltage is applied according to the present embodiment. In the example in FIG. 11, the voltage is applied to the reaction solution RS, so that the wettability is changed from hydrophobic to hydrophilic. Therefore, in FIG. 11, the reaction solution RS falls under the influence of gravity and is contained in the photometric area 2013. Thus, a possibility of photometric errors can be reduced.

Referring back to FIG. 5, and the description continues. After the processing in step S107, in step S108, similar to the processing in step S103, the control function 81 performs photometry after dispense and stirring of the first reagent. Next, in step S109, similar to the processing in step S104, the control function 81 stops applying the voltage to the reaction solution.

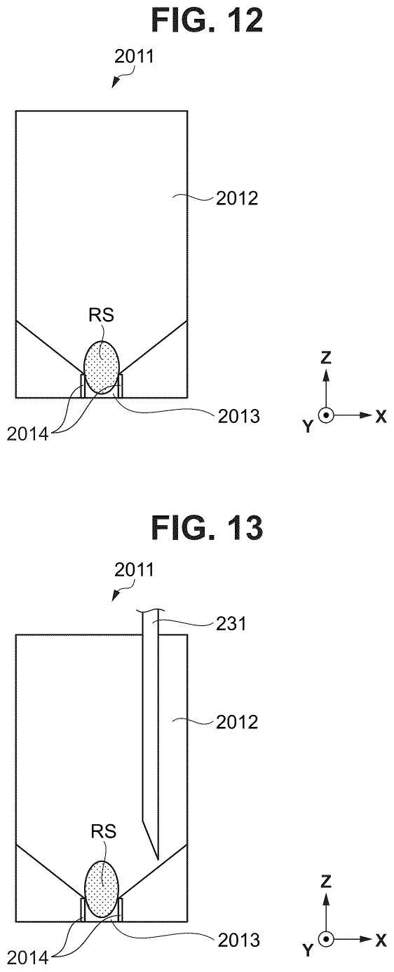

FIG. 12 is a diagram illustrating an example of the reaction solution when application of the voltage is stopped according to the embodiment. In the example illustrated in FIG. 12, the voltage is not applied to the reaction solution RS, and the wettability is hydrophobic.

Therefore, in FIG. 12, a portion of the reaction solution RS being in contact with the side wall of the photometric area 2013 is decreased in comparison to a state in which the wettability is hydrophilic (see FIG. 11). Further, in FIG. 12, a portion of the reaction solution RS present in the reaction area 2012 is increased in comparison to a state in which the wettability is hydrophilic (see FIG. 11). Thus, it is possible to reduce a possibility that reaction of the test sample and the first reagent may not proceed as expected.

Referring back to FIG. 5, and the description continues. After the processing in step S109, in step S110, similar to the processing in step S107, the control function 81 applies a voltage to the reaction solution at a timing when final photometry is performed (i.e., at a timing when a predetermined reaction time has passed since the first reagent has been dispensed).

Next, in step S111, similar to the processing in step S108, the control function 81 performs final photometry of the reaction solution. By the processing, test data is generated by the light detection device 222 of the photometric unit 220 and is outputted to the processing circuitry 8.

Next, in step S112, similar to the processing in step S109, the control function 81 stops applying the voltage to the reaction solution. Next, in step S113, the control function 81 aspirates the reaction solution as a waste solution. For example, the control function 81 controls the first waste solution nozzle 231 of the cleaning unit 230 and aspirates the reaction solution in the reaction vessel 2011 positioned at the reaction vessel cleaning position as a waste solution.

FIG. 13 is a diagram illustrating an example of the processing for aspiration of the reaction solution according to the embodiment. FIG. 13 illustrates a state of the reaction vessel 2011 when aspiration of the reaction solution RS by the first waste solution nozzle 231 is started.

In the example in FIG. 13, the voltage is not applied to the reaction solution RS, and the wettability is hydrophobic. Therefore, the reaction solution RS is brought into a state similar to the state illustrated in FIG. 12. Thus, it is possible to prevent a situation where the reaction solution RS adhered to the side wall of the photometric area 2013 of the reaction vessel 2011 remains without being completely aspirated by the first waste solution nozzle 231.

Referring back to FIG. 5, and the description continues. After the processing in step S113, in step S114, the control function 81 dispenses a cleaning solution. For example, the control function 81 controls the cleaning nozzle 232 of the cleaning unit 230 and dispenses the cleaning solution to the reaction vessel 2011 positioned at the reaction vessel cleaning position.

FIG. 14 is a diagram illustrating an example of a cleaning solution CS dispensed into the reaction vessel 2011 according to the embodiment. In the example in FIG. 14, a voltage is not applied to the cleaning solution CS dispensed to the reaction vessel 2011 by the cleaning nozzle 232, and the wettability is hydrophobic. Thus, even under the influence of gravity, the cleaning solution CS does not fall due to the influence of the surface tension and stays at the bottom portion of the reaction area 2012.

Referring back to FIG. 5, and the description continues. After the processing in step S114, in step S115, similar to the processing in step S102, the control function 81 applies a voltage to the cleaning solution.

FIG. 15 is a diagram illustrating an example of the cleaning solution to which the voltage is applied according to the present embodiment. In the example in FIG. 15, the voltage is applied to the cleaning solution CS, and the wettability is changed from hydrophobic to hydrophilic. Thus, in FIG. 15, the cleaning solution CS falls under the influence of gravity and is contained in the photometric area 2013. Therefore, the photometric area 2013 can be cleaned with the cleaning solution.

Referring back to FIG. 5, and the description continues. After the processing in step S115, in step S116, the control function 81 stirs the cleaning solution. For example, the control function 81 controls the cleaning stirring arm 233 of the cleaning unit 230 and stirs the cleaning solution dispensed to the reaction vessel 2011 by the cleaning stirrer.

FIG. 16 is a diagram illustrating an example of processing for stirring the cleaning solution in the reaction vessel 2011 according to the embodiment. Similar to the example in FIG. 15, in the example illustrated in FIG. 16, the wettability of the cleaning solution CS is hydrophilic. Accordingly, a state in which the cleaning solution CS is retained in the photometric area 2013 continues.

With this configuration, the cleaning solution CS can be distributed thoroughly to the reaction area 2012 and the photometric area 2013 by being stirred with the cleaning stirrer of the cleaning stirring arm 233. Thus, it is possible to prevent occurrence of cleaning failure.

Referring back to FIG. 5, and the description continues. After the processing in step S116, in step S117, similar to the processing in step S104, the control function 81 stops applying the voltage to the cleaning solution. Next, in step S118, the control function 81 aspirates the cleaning solution as a waste solution, and ends the processing.

For example, the control function 81 controls the second waste solution nozzle 234 of the cleaning unit 230 and aspirates the cleaning solution in the reaction vessel 2011 positioned at the reaction vessel cleaning position as a waste solution.

FIG. 17 is a diagram illustrating an example of the processing for aspiration of the cleaning solution according to the embodiment. FIG. 17 illustrates a state of the reaction vessel 2011 when aspiration of the cleaning solution CS by the second waste solution nozzle 234 is started.

In the example in FIG. 17, a voltage is not applied to the cleaning solution CS, and the wettability is hydrophobic. Therefore, the cleaning solution CS is brought into a state similar to the state illustrated in FIG. 15. Consequently, it is possible to prevent a situation where the cleaning solution CS adhered to the side wall of the photometric area 2013 of the reaction vessel 2011 remains partially aspirated by the second waste solution nozzle 234, which may affect the next measurement.

While, for the sake of simplicity, the above embodiment has been described using a case in which a measurement of a test item without the second reagent is performed, in a case where a measurement of a test item using a second reagent is performed, after the processing in step S109, the processing similar to the processing in steps S105 to S109 is performed with respect to the second reagent, and the processing may proceed to step S110.

Further, the above-described timing for applying the voltage is merely an example, and the timing for applying the voltage is not limited to the above. For example, after the voltage is applied in step S107, the voltage may continuously be applied until the processing in step S111. In this case, after the photometry in step S108, photometry may be performed repeatedly at a predetermined time interval until the final photometry is performed in step S111.

As described above, the automatic analysis apparatus 1 according to the present embodiment includes the reaction vessel 2011 having the reaction area 2012 and the photometric area 2013. Further, the automatic analysis apparatus 1 introduces the reaction solution of a mixture of the test sample and the first reagent into the photometric area 2013 by applying the voltage and changing the wettability of the reaction solution, and measures the absorbance of the reaction solution introduced into the photometric area 2013.

In this way, even in a case where a size of the photometric area 2013 is reduced, for example, the automatic analysis apparatus 1 according to the present embodiment can move the reaction solution contained in the reaction area 2012 to the photometric area 2013 without spending much time by changing the wettability of the reaction solution to decrease the influence of the surface tension of the reaction solution. In other words, the automatic analysis apparatus 1 according to the present embodiment can efficiently introduce a small amount of solution into the photometric area 2013 of the reaction vessel 2011. Further, the automatic analysis apparatus 1 according to the present embodiment can reduce a possibility of occurrence of a situation in which the reaction solution fails to move to the photometric area 2013, and the optical characteristics of the reaction solution cannot be measured properly.

The above-described embodiment can be modified and implemented as appropriate by changing a part of the configuration or the functions of the automatic analysis apparatus 1. Some variation examples according to the above-described embodiment are described below as other embodiments. Hereinafter, the content different from the above-described embodiment is mainly described, and detailed descriptions common to the already described details are omitted. Further, the variation examples described below may be implemented individually, or may be implemented in combination as appropriate.

### Variation Example 1

In the above-described embodiment, the photometric area 2013 has a bottom, and a reaction solution in the reaction vessel 2011 is aspirated and removed by the first waste solution nozzle 231 inserted into the reaction vessel 2011 from above the reaction vessel 2011 in the vertical direction. In Variation Example 1, the photometric area 2013 does not have a bottom, and the reaction solution in the reaction vessel 2011 is removed by being discharged downward in the vertical direction.

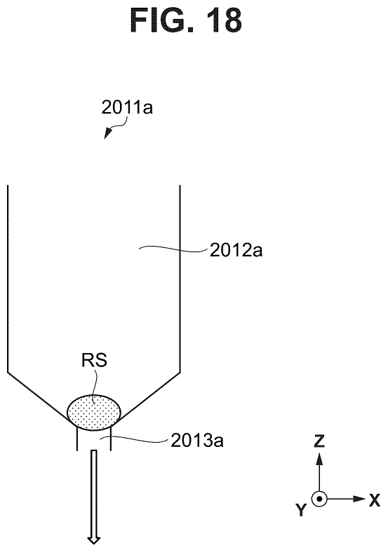

FIG. 18 is a diagram illustrating an example of a configuration of a reaction vessel 2011a according to the present variation example. As illustrated in FIG. 18, a photometric area 2013a of the reaction vessel 2011a does not have a bottom. Further, a waste solution tube (not illustrated) disposed downward in the vertical direction is connected to the photometric area 2013a of the present variation example. The waste solution tube is connected to a waste solution tank (not illustrated) for storing a waste solution.

While, similar to the above-described embodiment, the wettability of the reaction solution is changed by application of a voltage to introduce the reaction solution into the photometric area 2013, in the present variation example, after photometry is performed, the reaction solution RS is discharged downward in the vertical direction and is delivered to the waste solution tank through the waste solution tube.

The discharge of the reaction solution RS downward in the vertical direction may be performed by utilizing gravity or by using a pump or the like. Further, although it is not illustrated, the cleaning solution is also discharged downward in the vertical direction in the similar manner as illustrated in FIG. 18.

According to the present variation example, the waste solution in the reaction vessel 2011a can be discharged even without providing a waste solution nozzle for aspirating the waste solution.

### Variation Example 2

In the above-described embodiment, the conductive layer 2014 and the hydrophobic layer 2015 are disposed on the side wall of the photometric area 2013. In the present variation example, electrodes for changing wettability of a solution contained in a photometric area are disposed independently of a reaction vessel, instead of disposing the conductive layer 2014 and the hydrophobic layer 2015 on the side wall of the photometric area 2013.

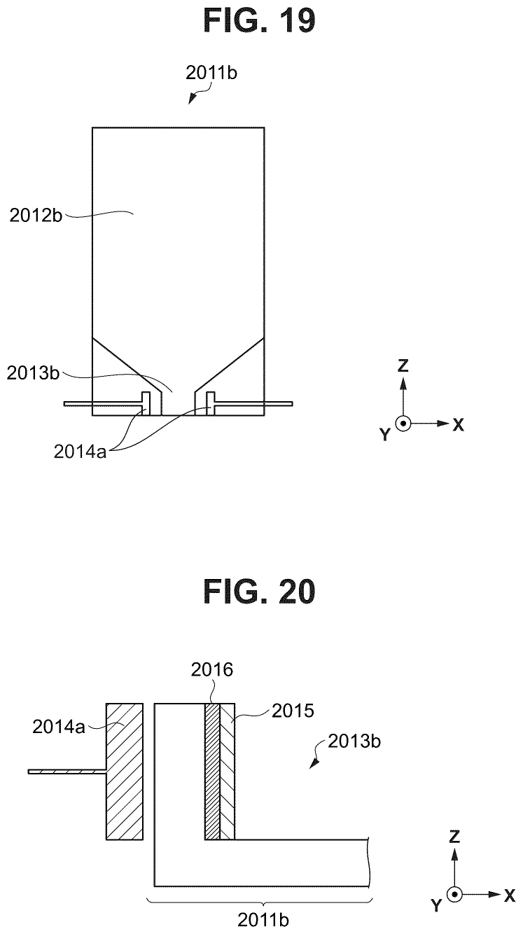

FIGS. 19 and 20 are front views each illustrating an example of the configuration of a reaction vessel 2011b according to Variation Example 2. FIG. 20 illustrates an enlarged portion of the reaction vessel 2011b illustrated in FIG. 19.

As illustrated in FIG. 19, different from the above-described embodiment, the conductive layer 2014 is not disposed on a photometric area 2013b of the reaction vessel 2011b according to the present variation example. Further, in the present variation example, independently of the reaction vessel 2011b, electrodes 2014a are disposed at positions spaced apart from a side wall of the photometric area 2013b. In other words, the electrodes 2014a are disposed outside the reaction vessel 2011b.

Further, as illustrated in FIG. 20, a hydrophobic layer 2015 and a dielectric layer 2016 are formed on the inside surface of the photometric area 2013b. It can also be said that the dielectric layer 2016 is covered with the hydrophobic layer 2015. The dielectric layer 2016 is a layer formed of a dielectric material, to which a voltage is to be applied. For example, the dielectric layer 2016 is formed of a material, such as glass or polymethyl methacrylate (PMMA).

In a case where the reaction vessel 2011b is formed of glass, the glass serves as the dielectric layer 2016, so it is not necessary to additionally provide the dielectric layer 2016. Further, in the above-described embodiment, the side wall SW illustrated in FIG. 4 serves the function similar to the function of the dielectric layer 2016.

According to the present variation example, since a commonly used electrode can be utilized as a structure for changing the wettability, it is considered possible to reduce the manufacturing cost of the reaction vessel.

### Variation Example 3

While, in the above-described embodiment, the conductive layer 2014 and the hydrophobic layer 2015 are disposed on the side wall of the photometric area 2013, a conductive layer and a hydrophobic layer may be disposed on a reaction area.

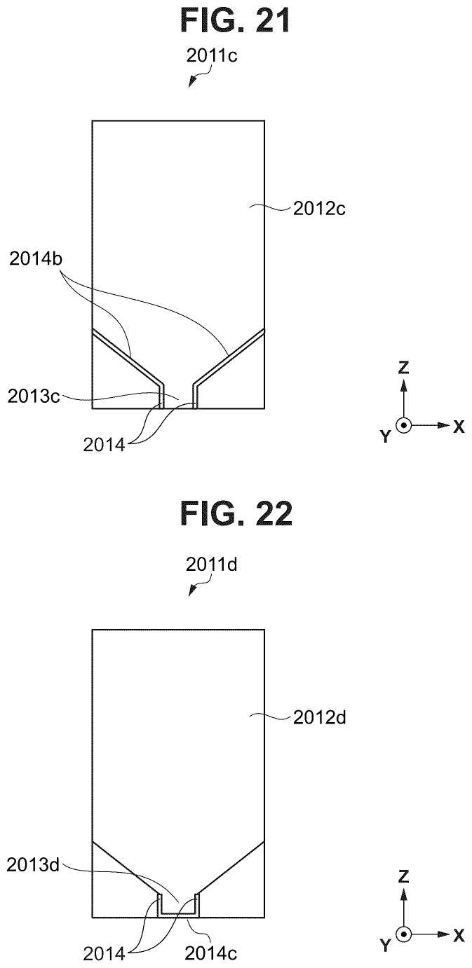

FIG. 21 is a front view illustrating an example of a configuration of a reaction vessel 2011c according to Variation Example 3. As illustrated in FIG. 21, in the present variation example, a conductive layer 2014b is disposed on the outer surface of a tapered bottom portion of a reaction area 2012c. Further, a hydrophobic layer 2015 (not illustrated) similar to the hydrophobic layer 2015 according to the above-described embodiment is formed on the outer surface of the tapered bottom portion of the reaction area 2012c.

### Variation Example 4

In the above-described embodiment, the conductive layer 2014 and the hydrophobic layer 2015 are provided on the side wall of the photometric area 2013. However, a conductive layer and a hydrophobic layer may be provided on a bottom of a photometric area.

FIG. 22 is a front view illustrating an example of a configuration of a reaction vessel 2011d according to Variation Example 4. As illustrated in FIG. 22, in the present variation example, a conductive layer 2014c is disposed on the outer surface of a bottom of a photometric area 2013d. Further, a hydrophobic layer 2015 (not illustrated) similar to the hydrophobic layer 2015 according to the above-described embodiment is also formed on the outer surface of the bottom of the photometric area 2013d.

### Variation Example 5

In the above-described embodiment, the automatic analysis apparatus 1 includes the input interface 4, the display 5, the printer 6, the storage circuitry 7, and the processing circuitry 8. However, the configuration of the automatic analysis apparatus 1 is not limited thereto.

For example, the functions of the input interface 4, the display 5, the printer 6, the storage circuitry 7, and the processing circuitry 8 can be replaced by functions of an information processing apparatus, such as a personal computer or workstation, and an external printer with respect to the automatic analysis apparatus 1.

For example, in a case where an information processing apparatus and an external printer are connected to the automatic analysis apparatus 1, the respective functions of the input interface 4, the display 5, the storage circuitry 7, and the processing circuitry 8 can be replaced by functions of an input interface, a display, a storage circuitry, and a processing circuitry included in the information processing apparatus, and the functions of the printer 6 can be replaced by functions of the external printer.

In a case where the functions are replaced by functions of the information processing apparatus and the external printer, the automatic analysis apparatus 1 is not necessarily required to include the input interface 4, the display 5, the printer 6, the storage circuitry 7, and the processing circuitry 8.

The term “processor” used in the above description refers to, for example, a Central Processing Unit (CPU), a Graphics Processing Unit (GPU), an Application Specific Integrated Circuit (ASIC), or a programmable logic device (e.g., a Simple Programmable Logic Device (SPLD), a Complex Programmable Logic Device (CPLD), or a Field Programmable Gate Array (FPGA)).

The processor realizes its functions by reading and performing a program stored in storage circuitry. Alternatively, instead of storing the program in the storage circuitry 7, the processor may be configured to have the program directly embedded within its circuitry. In such a case, the processor realizes its functions by reading and executing the embedded program.

Each processor in the present embodiment may be configured not only as single circuitry per processor, but also as a combination of multiple independent circuitry functioning as a single processor. Furthermore, multiple components illustrated in the drawings may be integrated into a single processor to realize their functions.

The components of each device illustrated in the drawings are conceptual representations of functions and are not necessarily configured physically as illustrated. That is, the specific forms of distribution and integration of each device are not limited to those illustrated in the drawings, and all or part of the components may be functionally or physically distributed or integrated in any unit depending on various loads or usage conditions.

Moreover, the processing functions that are performed by each device may be realized entirely or partially by a CPU and a program performed by the CPU, or may be implemented as hardware using wired logic.

Additionally, among the processes described in the above embodiment, those described as being performed automatically may be performed manually in whole or in part, and those described as being performed manually may be performed automatically in whole or in part using known methods. Furthermore, unless otherwise specified, the processing procedures, control procedures, specific names, and information including various data and parameters described in the above document and drawings may be changed as needed.

The automatic analysis method described in the above embodiment may be implemented by performing a pre-prepared control program on a computer, such as a personal computer or workstation. This control program may be distributed via a network, such as the Internet. The control program may also be recorded on a computer-readable recording medium, such as a hard disk, a flexible disk (FD), a compact disc read-only memory (CD-ROM), a magneto-optical disc (MO), or a digital versatile disc (DVD), and performed by being read from the recording medium by a computer.

According to at least any one of the above-described embodiments, a small amount of solution can be efficiently introduced into a photometric area of a reaction vessel.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An automatic analysis apparatus that analyzes a liquid sample by measuring optical characteristics, comprising:
a reaction vessel configured to contain a mixed solution of the liquid sample and a reagent, and have a reaction area where the mixed solution is caused to react, and a photometric area provided below the reaction area in a vertical direction, the photometric area being a target for a measurement of the optical characteristics;
an introduction unit configured to introduce the mixed solution into the photometric area by applying a voltage to change wettability of the mixed solution to an inside surface of the photometric area; and
a photometric system configured to measure the optical characteristics of the mixed solution introduced into the photometric area.

2. The automatic analysis apparatus according to claim 1, further comprising an electrode disposed on at least one surface of a side wall of the photometric area, the surface being an opposite side of another surface which comes into contact with the mixed solution when the optical characteristics are measured,
wherein the introduction unit applies a voltage by the electrode.

3. The automatic analysis apparatus according to claim 2, wherein the electrode is disposed to be in contact with the side wall.

4. The automatic analysis apparatus according to claim 2, wherein the electrode is disposed to be spaced apart from the side wall.

5. The automatic analysis apparatus according to claim 1, wherein a lower end portion of the reaction area in the vertical direction is formed in a tapered shape that becomes narrower toward the photometric area.

6. The automatic analysis apparatus according to claim 1, wherein a volume of the photometric area is smaller than a volume of the reaction area.

7. The automatic analysis apparatus according to claim 6, wherein a length of the photometric area in a front-rear direction is longer than a length in a width direction.

8. A reaction vessel for containing a mixed solution of a liquid sample and a reagent, the reaction vessel comprising:
a reaction area configured to cause the mixed solution to react; and
a photometric area disposed below the reaction area in a vertical direction and configured to be a target where optical characteristics of the mixed solution are measured;
wherein wettability of the mixed solution to an inside surface of the photometric area is changed by application of a voltage.

9. The reaction vessel according to claim 8, further comprising:
a hydrophobic layer formed of a hydrophobic material and disposed on at least one surface of a side wall of the photometric area, the surface being in contact with the mixed solution when the optical characteristics are measured; and
a dielectric layer formed of a dielectric material, to which a voltage is applied, the dielectric layer being in contact with the hydrophobic layer.
